(19) United States
(12) Patent Application Publication
(10) Pub. No.: US 2011/0239544 A1
(43) Pub. Date: Oct. 6, 2011

(54) WINDOW BUBBLE SYSTEM

(76) Inventor: Sandy Klee, Errington (CA)

(21) Appl. No.: 13/047,756

(22) Filed: Mar. 14, 2011

Related U.S. Application Data
(60) Provisional application No. 61/318,848, filed on Mar. 30, 2010.

(51) Int. Cl. E06B 7/16; E06B 3/30

(52) U.S. Cl. 49/480.1; 49/475.1; 49/506

(57) ABSTRACT

A window accessory and sealing system offering an inexpensive, but efficient, alternative to replacing old windows with new windows. The window accessory and sealing system can be installed over a home's existing windows to effectively prevent heat loss and reduce utility bills. The product offers additional thermal insulation to effectively ensure that heat does not escape and cold air does not enter therein. The window accessory and sealing system comprising: a window; a convex window accessory with a one-way check valve. The window accessory is removably sealably-coupleable to the window to create an enclosed evacuatable inner volume. The one-way check valve is located on the convex window accessory and is used to create a vacuum seal between the window and the convex window accessory to minimize heat loss.

### CROSS-REFERENCE TO RELATED APPLICATION

The present application is related to and claims priority from prior provisional application Ser. No. 61/318,848, filed Mar. 30, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of windows and more specifically relates to a window accessory and sealing system to prevent heat loss and reduce utility bills thereby also preventing homeowners from having to purchase new windows.

### DESCRIPTION OF THE RELATED ART

A window is a transparent opening in a wall or door that allows the passage of light and, if not closed or sealed, air and sound. Windows are usually glazed or covered in some other transparent or translucent material like a float glass. Windows are typically held in place by frames, which prevent them from collapsing inwardly. Many glazed windows may be opened, to allow ventilation, or closed, to exclude inclement weather.

Window coverings are material used to cover a window to manage sunlight, to provide additional weatherproofing, to substantially ensure privacy or for purely decorative purposes. Window Coverings, especially in the US market, are usually on the interior side of windows, but exterior solutions may also be available.

Many homes have older windows that can negatively effect a home's heating capabilities. Older windows tend to let cold air in from the outside and permit warm air from inside the home to escape. This causes a home's heating system to overcompensate to try and maintain the proper temperature. This often results in inflated utility bills, which can put unnecessary strain on homeowners. Installing new windows may be a pricey endeavor and may not always be feasible. Therefore a need exists for a window accessory and sealing system to prevent heat loss and reduce utility bills thereby avoiding the need for homeowners to purchase new windows.

Various attempts have been made to solve the above-mentioned problems such as those found in U.S. Pat. Nos. 5,937,595; 3,990,201; 5,809,707; 5,242,207; 6,047,500; 6,209,269; and 5,447,123. This prior art is representative of window coverings. None of the above inventions and patents, taken either singly or in combination, is seen to describe the invention as claimed.

Ideally, a window accessory and sealing system should be user-friendly, operate reliably and be manufactured at a modest expense. Thus, a need exists for a reliable window bubble system to prevent heat loss and reduce utility bills thereby avoiding the need for homeowners to purchase new windows and to avoid the above-mentioned problems.

### BRIEF SUMMARY OF THE INVENTION

In view of the foregoing disadvantages inherent in the known window covering art, the present invention provides a novel window bubble system. The general purpose of the present invention, which will be described subsequently in greater detail is to provide an inexpensive, but efficient, alternative to replacing old windows with new windows. The window bubble system can be installed over a home's existing windows to prevent heat loss and reduce utility bills. The product offers additional thermal insulation to effectively ensure that heat does not escape and cold air does not enter the protected area (home interior). The product may be made of shatter resistant plexiglass and can be easily installed by the homeowner. The plexiglass helps to filter sunlight and may also act as a storm window. This product provides homeowners with a cost-effective alternative to purchasing new windows.

The present window accessory and sealing system disclosed herein comprises: at least one window; at least one convex window accessory with a one-way check valve. The window accessory may be flexible and is removably sealably-coupleable to the window to create an enclosed evacuatable inner volume. A periphery of the convex window accessory seals to the window. The seal may comprise deformable rubber. The convex window accessory creates an insulated-bubble-zone as an insulative-resistance means.

Further, the convex window accessory comprises shatter resistant plexi-glass comprising UV protective properties and is translucent. The convex window accessory is sealably-installable on both an interior and an exterior of a window. The one-way check valve may be located on the convex window accessory and is used to create a vacuum seal between the window and the window accessory to minimize heat loss. The one-way check valve may be located in a bottom right hand corner of the window accessory. The valve works in conjunction with an air removing tool. The air removing tool is removably coupleable to the one-way check valve such that a valve may be user-manipulated to eliminate excess air thereby creating a vacuum seal.

A kit is also embodied herein for the window bubble system which may comprise: at least one convex window accessory; an air removing tool; and a set of user instructions.

In accordance with the embodiments of the present invention a preferred method of use is disclosed herein comprising: mounting at least one convex window accessory to a window; inserting an air removing tool onto a one-way check valve located on the convex window accessory; removing excess air using the air removing tool from the convex window accessory via the one-way check valve thereby creating a vacuum seal between the convex window and the window; and removing the convex window accessory during non-use periods.

The present invention holds significant improvements and serves as a window bubble system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, window bubble system, constructed and operative according to the teachings of the present invention.

FIG. 1 is a perspective view illustrating a window bubble system in an ‘in-use’ condition according to an embodiment of the present invention.

FIG. 2 is a perspective view illustrating a one-way check valve and an air removing tool of window bubble system according to an embodiment of the present invention of FIG. 1.

FIG. 3 is a perspective view illustrating a user using the air removing tool on a window accessory to create a vacuum seal using the window bubble system according to an embodiment of the present invention of FIG. 1.

FIG. 4 is a perspective view illustrating another view of the window accessory according to an embodiment of the present invention of FIG. 1.

FIG. 5 is a flowchart illustrating a method of use for the window bubble system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a window accessory and more particularly to window bubble system 100 to prevent heat loss and reduce utility bills thereby avoiding the need for homeowners to purchase new windows.

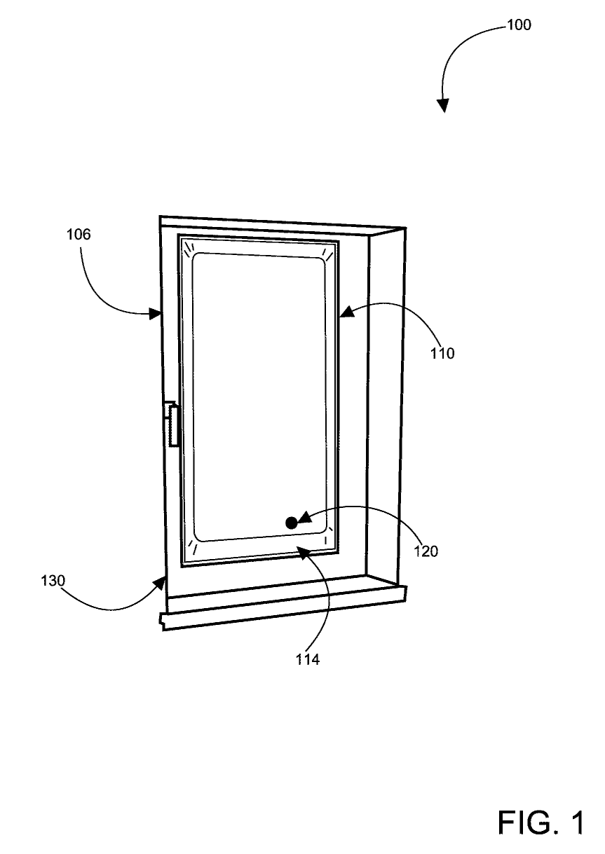

Referring now to FIG. 1 showing a perspective view of window bubble system 100 in an ‘in-use’ condition 106 according to an embodiment of the present invention. Window bubble system 100 preferably comprises window accessory 110 with one-way check valve 120. Window accessory 110 is preferably removably sealably-coupleable to window 130 thereby creating an enclosed evacuatable inner volume to effectively ensure that heat does not escape and cold air does not enter window 130 (into interior of building) as alluded to in FIG. 1 in ‘in-use’ condition 106. Additionally, window accessory 110 preferably creates an insulated-bubble-zone as a resistance to heat loss means. Window accessory 110 may be flexible thereby increasing the ease of installing window accessory 110 to window 130 due to an increased range of motion and movement/bendability of window accessory 110.

Further, window accessory 110 is preferably convex (in relation to window 130) and comprises plexi-glass or Poly(methyl methacrylate). Poly(methyl methacrylate) (PMMA) is a transparent thermoplastic, used as a light-weight alternative to glass and because it is safer in use. Further, PMMA is an economical alternative to polycarbonate (PC) when extreme strength is not necessary. PMMA does not contain the potentially harmful bisphenol-A subunits found in polycarbonate. It exhibits moderate properties, for ease of handling and processing, and low cost. Additionally, the PMMA is shatter resistant and comprises UV protective properties. Window accessory 110 is preferably translucent and/or transparent due to the chemical properties of the plexi-glass thereby permitting user 310 to see through window 130 unobstructed. In certain embodiments user may choose to tint, frost or otherwise change transparency to increase privacy.

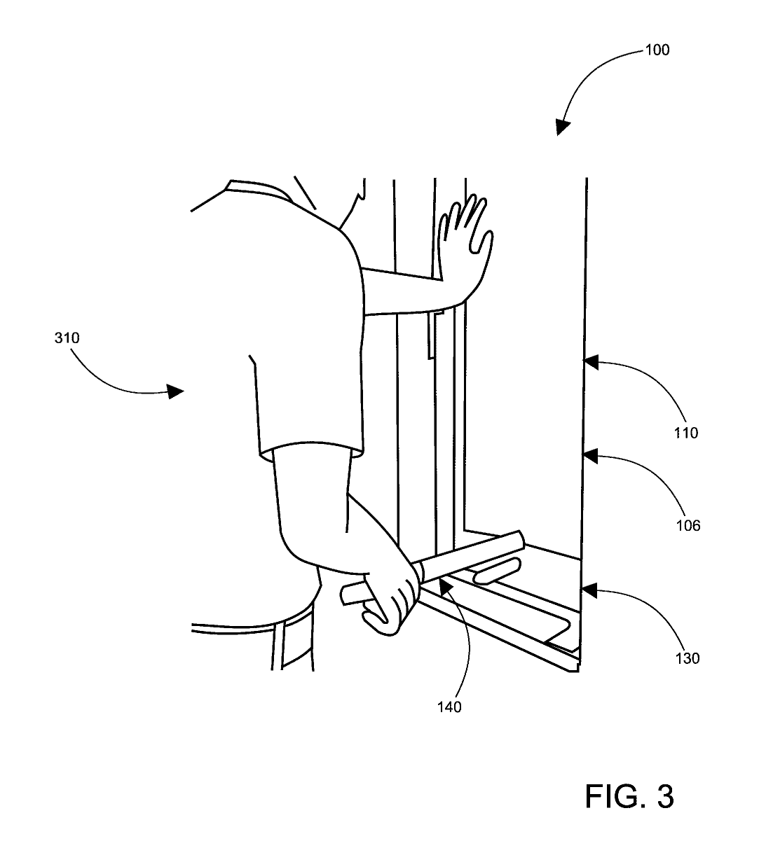

One-way check valve 120 is preferably located on window accessory 110 and is used as a closeable through hole to create a vacuum seal between window 130 and window accessory 110 to minimize heat loss during the installation process as shown in FIG. 3. One-way check valve 120 is shown located in bottom right hand corner 114 of window accessory 110.

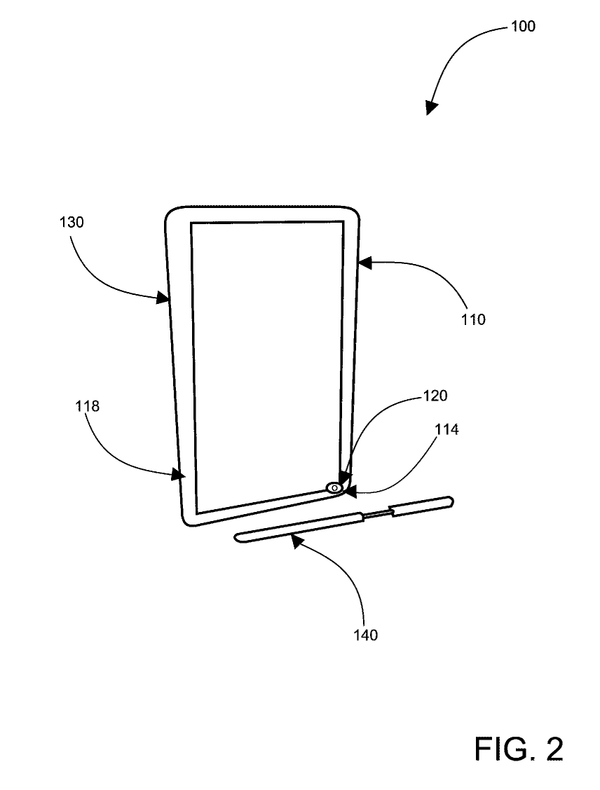

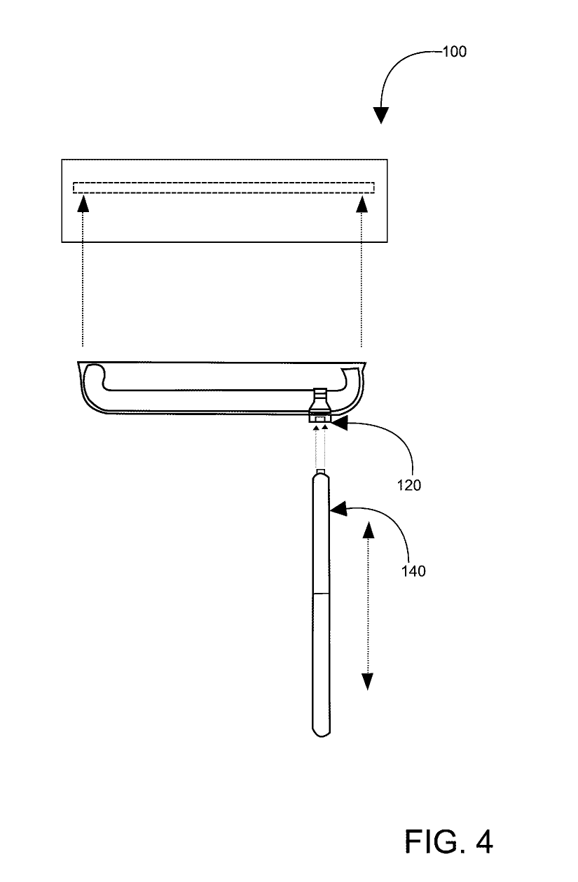

Referring now to FIGS. 2-4 showing perspective views of window accessory 110 of window bubble system 100 according to embodiments of the present invention. Periphery 118 of window accessory 110 may seal to window 130. This seal comprises deformable rubber or other such deformable material. Window accessory 110 is sealably-installable on both an interior and an exterior of window 110 depending on how much heat loss user 310 requires as to the installation location (interior and/or exterior) of window accessory 110.

One-way check valve 120 works in conjunction with a ‘mating’ air removing tool 140. Air removing tool 140 is removably coupleable to one-way check valve 120 such that a valve may be user-manipulated to eliminate excess air thereby creating a vacuum seal. Air removing tool 140 is removably coupleable to one-way check valve 120 via a female and male connector or a snap fit. Air removing tool 140 preferably acts as a vacuum pump or a device that removes gas/air from a sealed volume in order to leave behind a partial vacuum. The vacuum environment removes atmospheric gases, thereby preventing window 130 from allowing heat to escape and cold air to enter window 130 (due to the resistance created by lack of communication transfer medium—a lack of air present).

Window bubble system 100 according to an embodiment of the present invention of FIGS. 1-4 may comprise a kit. The kit may comprise the following parts: window accessory 110; air removing tool 140; and a set of user instructions.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, alternate fastening means, various sizes and contours, etc., may be sufficient.

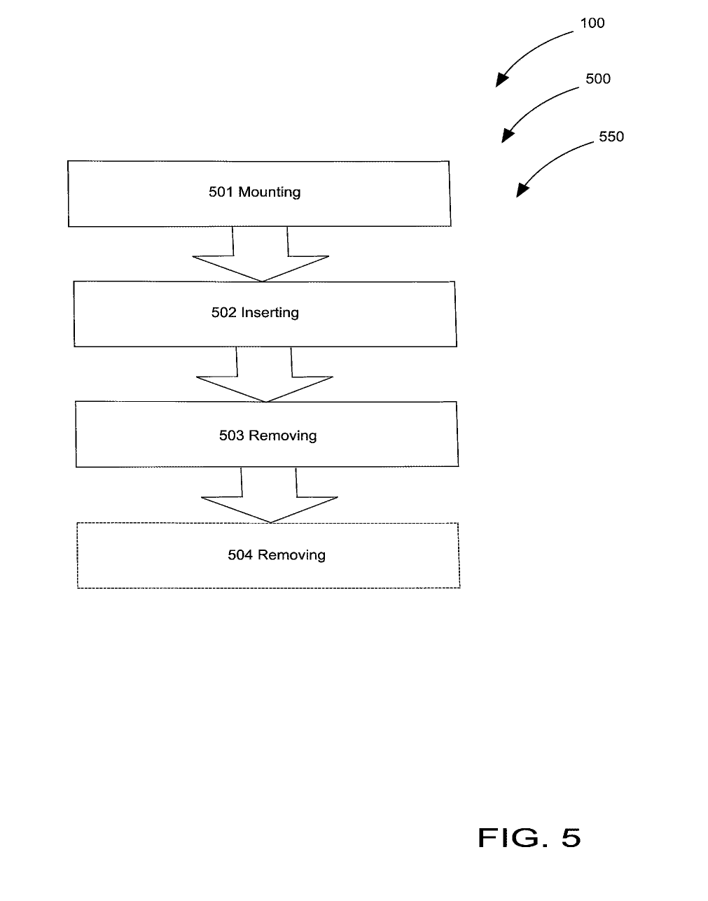

Referring now to FIG. 5. showing flowchart 550 illustrating method of use 500 according to an embodiment of the present invention of FIGS. 1-4. A method of using window bubble system 100 preferably comprising the steps of: step one 501 mounting window accessory 110 to window 130; step two 502 inserting air removing tool 140 onto one-way check valve 120 located on window accessory 110; step three 503 removing excess air using air removing tool 140 from window accessory 110 via one-way check valve 120 thereby creating a vacuum seal between window accessory 110; and step four 504 removing window accessory 110 during non-use periods.

It should be noted that step four 504 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A window accessory and sealing system comprising:
at least one window;
at least one convex window accessory; and
a one-way check valve;
wherein said window accessory is removably sealably-coupleable to said window to create an enclosed evacuatable inner volume; and
wherein said one-way check valve is located on said convex window accessory and is used to create a vacuum seal between said at least one window and said convex window accessory to minimize heat loss.

2. The window accessory and sealing system of claim 1 wherein a periphery of said convex window accessory is used to seal said convex window accessory to said window.

3. The window accessory and sealing system of claim 2 wherein said seal comprises deformable rubber.

4. The window accessory and sealing system of claim 1 wherein convex window accessory creates an insulated-bubble-zone.

5. The window accessory and sealing system of claim 1 wherein said convex window accessory is flexible.

6. The window accessory and sealing system of claim 1 wherein said convex window accessory comprises plexi-glass.

7. The window accessory and sealing system of claim 6 wherein said plexi-glass is shatter resistant.

8. The window accessory and sealing system of claim 6 wherein said plexi-glass comprises UV protective properties.

9. The window accessory and sealing system of claim 1 wherein said convex window accessory is translucent.

10. The window accessory and sealing system of claim 1 wherein said convex window accessory is sealably-installable on both an interior and an exterior of said window.

11. The window accessory and sealing system of claim 1 wherein said one-way check valve is located in a bottom right hand corner of said convex window accessory.

12. The window accessory and sealing system of claim 11 wherein said one-way check valve works in conjunction with an air removing tool via a male/female removably couplable relationship.

13. The window accessory and sealing system of claim 12 wherein said air removing tool is removably coupleable to said one-way check valve such that a valve may be user-manipulated to eliminate excess air thereby creating a vacuum seal.

14. A window accessory and sealing system comprising:
at least one window;
at least one flexible, translucent, shatter resistant plexi-glass convex window accessory wherein a periphery of said at least one convex window accessory seals to said window thereby creating an insulated-bubble-zone; and
a one-way check valve;
wherein said window accessory is removably sealably-coupleable to said window to create an enclosed evacuatable inner volume;
wherein said one-way check valve is located on said convex window accessory and is used to create a vacuum seal between said at least one window and said convex window accessory to minimize heat loss and transfer;
wherein said seal comprises deformable rubber;
wherein said plexi-glass comprises UV protective properties;
wherein said convex window accessory is sealably-installable on both an interior and an exterior of said window;
wherein said one-way check valve is located in a bottom right hand corner of said convex window accessory;
wherein said one-way check valve works in conjunction with an air removing tool; and
wherein said air removing tool is removably coupleable to said one-way check valve such that a valve may be user-manipulated to eliminate excess air thereby creating a vacuum seal.

15. The window accessory and sealing system of claim 14 further comprising a kit including: said at least one convex window accessory; said air removing tool; and a set of user instructions.

16. A method of using window accessory and sealing system comprising the steps of:
mounting at least one convex window accessory to a window;
inserting an air removing tool onto a one-way check valve located on said convex window accessory; and
removing excess air using said air removing tool from said convex window accessory via said one-way check valve thereby creating a vacuum seal between said convex window and said window.

17. The method of claim 16 further comprising the step of removing said convex window accessory during non-use periods.
